(19) United States
(12) Patent Application Publication
(10) Pub. No.: US 2026/0019306 A1
(43) Pub. Date: Jan. 15, 2026

(54) COMPRESSED SENSING-BASED NEAR-FIELD CHANNEL ESTIMATION METHOD AND APPARATUS FOR EXTRA-LARGE-SCALE MASSIVE MULTIPLE-INPUT MULTIPLE-OUTPUT (XL-MIMO), DEVICE, AND STORAGE MEDIUM

(71) Applicant: GUANGDONG POWER GRID CO., LTD., Guangzhou (CN)

(72) Inventor: Ying Sun, Guangzhou (CN)

(21) Appl. No.: 19/286,197

(22) Filed: Jul. 30, 2025

Related U.S. Application Data
(63) Continuation-in-part of application No. PCT/CN2024/107451, filed on Jul. 25, 2024.

(30) Foreign Application Priority Data
Jul. 15, 2024 (CN) 202410942954.8

(51) Int. Cl. H04L 25/02; H04B 7/0413

(52) U.S. Cl. CPC H04L 25/0204; H04B 7/0413; H04L 25/0254

(57) ABSTRACT

Provided are a compressed sensing-based near-field channel estimation method and apparatus for extra-large-scale massive multiple-input multiple-output (XL-MIMO), a device, and a storage medium. The method includes: obtaining a channel vector of a compressed sensing-based near-field channel on which estimation is to be performed; inputting the channel vector into a constructed channel estimation model, such that the channel estimation model converts the channel vector into a polar-domain channel vector; compressing the polar-domain channel vector into a signal vector; adding noise to the signal vector, and obtaining a received signal vector; inputting the received signal vector into a built-in learned approximate message passing (LAMP) algorithm layer, such that the LAMP algorithm layer performs iteration on the received signal vector and calculates an estimated polar-domain channel vector corresponding to the polar-domain channel vector; and converting the estimated polar-domain channel vector into an estimate of the compressed sensing-based near-field channel.

### CROSS REFERENCE TO RELATED APPLICATIONS

The present application is a Continuation-In-Part Application of PCT Application No. PCT/CN2024/107451 filed on Jul. 25, 2024, which claims the benefit of Chinese Patent Application No. 202410942954.8 filed on Jul. 15, 2024. All the above are hereby incorporated by reference in their entirety.

### TECHNICAL FIELD

The present disclosure relates to the technical field of channel estimation, and in particular, to a compressed sensing-based near-field channel estimation method and apparatus for extra-large-scale massive multiple-input multiple-output (XL-MIMO), a device, and a storage medium.

### BACKGROUND

An extra-large-scale massive multiple-input multiple-output (XL-MIMO) technology, developed to meet stringent requirements of emerging services in sixth generation (6G) communications, is a promising communication technology expected to significantly improve performance. Similar to massive multiple-input multiple-output (MIMO) in the fifth generation (5G) communications, accuracy of channel state information (CSI) significantly affects performance of the XL-MIMO technology in wireless communications, making precise channel estimation crucial. In the prior art, in a near-field channel estimation scheme for an XL-MIMO system, sparsity of a near-field channel is represented by a polar domain, a transformation matrix is obtained through joint spatial angle and distance sampling, near-field channel estimation is performed using an orthogonal matching pursuit (OMP) algorithm in a compressed sensing (CS)-based method.

In the XL-MIMO technology, due to a dramatic increase in a quantity of antennas, traditional pilot design faces a huge overhead, which affects accuracy of channel estimation.

Therefore, how to reduce a pilot overhead for the near-field channel estimation is an urgent problem to be solved.

### SUMMARY

The present disclosure provides a compressed sensing-based near-field channel estimation method and apparatus for XL-MIMO, a device, and a storage medium, so as to reduce a pilot overhead for near-field channel estimation.

An embodiment of the present disclosure provides a compressed sensing-based near-field channel estimation method for XL-MIMO, including:
obtaining a channel vector of a compressed sensing-based near-field channel on which estimation is to be performed; and
inputting the channel vector into a channel estimation model constructed by a deep neural network, such that the channel estimation model converts the channel vector into a polar-domain channel vector by a built-in sparse transformation matrix;
compressing the polar-domain channel vector into a signal vector by a built-in sensing matrix;
adding noise to the signal vector, and obtaining a received signal vector;
inputting the received signal vector into a built-in learned approximate message passing (LAMP) algorithm layer, such that the LAMP algorithm layer performs an iterative calculation on the received signal vector by a built-in soft-thresholding function, and obtaining an estimated polar-domain channel vector corresponding to the polar-domain channel vector, where the soft-thresholding function is calculated based on a built-in linear transformation parameter, nonlinear transformation parameter, and linear transformation matrix; and
converting, by the built-in sparse transformation matrix, the estimated polar-domain channel vector into an estimate of the compressed sensing-based near-field channel on which estimation is to be performed.

Further, the method further includes: training the channel estimation model in two stages:
adjusting, in a first stage, an initial sensing matrix and an initial sparse transformation matrix based on a first loss function until the first loss function converges; and
adjusting, in a second stage, an initial linear transformation parameter, an initial nonlinear transformation parameter, and an initial linear transformation matrix based on a second loss function until the second loss function converges.

Further, the adjusting, in a first stage, an initial sensing matrix and an initial sparse transformation matrix based on a first loss function until the first loss function converges includes:
obtaining a plurality of first channel vectors with a first true label, and initializing values of the sensing matrix, the sparse transformation matrix, the linear transformation parameter, the nonlinear transformation parameter, and the linear transformation matrix in the to-be-trained channel estimation model, where the first true label is used to represent a true estimate of each of the first channel vectors;
inputting the first channel vector into the to-be-trained channel estimation model;
converting, by the to-be-trained channel estimation model, the first channel vector into a first polar-domain channel vector through the initial sparse transformation matrix;
compressing the first polar-domain channel vector into a first signal vector by the initial sensing matrix;
adding first noise to the first signal vector, and obtaining a first received signal vector;
inputting the first received signal vector into the built-in LAMP algorithm layer to calculate a final estimated polar-domain channel vector of the LAMP algorithm layer based on the initial linear transformation parameter, the initial nonlinear transformation parameter, the initial linear transformation matrix, and the initial sensing matrix;
obtaining, based on the initial sparse transformation matrix and the final estimated polar-domain channel vector, a first estimate corresponding to the first channel vector;
calculating a value of the first loss function based on the first channel vector, the first estimate, and a formula of the first loss function; and
after calculating one value of the first loss function each time, determining whether the first loss function converges currently; and if the first loss function does not converge currently, adjusting the value of the sensing matrix and the value of the sparse transformation matrix, and continuously training the to-be-trained channel estimation model; or if the first loss function converges currently, determining that the training of the to-be-trained channel estimation model in the first stage has been completed, and obtaining an optimized sensing matrix and an optimized sparse transformation matrix.

Further, the LAMP algorithm layer contains a plurality of algorithm sublayers;
for a first algorithm sublayer in the LAMP algorithm layer, a first soft-thresholding function of the first algorithm sublayer is calculated by the initial linear transformation parameter, the initial nonlinear transformation parameter, and the initial linear transformation matrix; and a first estimated polar-domain channel vector of the first algorithm sublayer is calculated based on the first soft-thresholding function and the first signal vector;
for a non-first algorithm sublayer in the LAMP algorithm layer, an estimated polar-domain channel vector of a current algorithm sublayer is calculated based on a current sensing matrix, an estimated polar-domain channel vector of a previous algorithm sublayer corresponding to the current algorithm sublayer, and a soft-thresholding function of the previous algorithm sublayer; and
the final estimated polar-domain channel vector of the LAMP algorithm layer is calculated based on estimated polar-domain channel vectors of all the algorithm sublayers in the LAMP algorithm layer.

Further, the adjusting, in a second stage, an initial linear transformation parameter, an initial nonlinear transformation parameter, and an initial linear transformation matrix based on a second loss function until the second loss function converges includes:
obtaining a plurality of second channel vectors with a second true label, where the second true label is used to represent a true estimate of each of the second channel vectors;
inputting the second channel vector into the channel estimation model in the second stage;
converting, by the to-be-trained channel estimation model, the second channel vector into a second polar-domain channel vector through the optimized sparse transformation matrix;
compressing the second polar-domain channel vector into a second signal vector by the optimized sensing matrix;
adding second noise to the second signal vector, and obtaining a second received signal vector;
inputting the second received signal vector into the built-in LAMP algorithm layer to calculate a second estimated polar-domain channel vector of each algorithm sublayer in the LAMP algorithm layer based on the initial linear transformation parameter, the initial nonlinear transformation parameter, the initial linear transformation matrix, and the optimized sensing matrix;
obtaining a second estimate of each algorithm sublayer based on the optimized sparse transformation matrix and the second estimated polar-domain channel vector of each algorithm sublayer;
after calculating a second estimate of an algorithm sublayer each time, calculating a value of a second loss function of the algorithm sublayer based on the second channel vector, the second estimate, and a formula of the second loss function; and
after calculating one value of the second loss function each time, determining whether a second loss function of a current algorithm sublayer converges; and if the second loss function of the current algorithm sublayer does not converge, fixing a linear transformation parameter, a nonlinear transformation parameter, and a linear transformation matrix of a previous algorithm sublayer corresponding to the current algorithm sublayer, adjusting a linear transformation parameter, a nonlinear transformation parameter, and a linear transformation matrix of the current algorithm sublayer, and continuously training the to-be-trained channel estimation model; or if the second loss function of the current algorithm sublayer converges, determining that the training of the to-be-trained channel estimation model in the second stage has been completed, and obtaining an optimized linear transformation parameter, an optimized nonlinear transformation parameter, and an optimized linear transformation matrix.

Further, the inputting the second received signal vector into the built-in LAMP algorithm layer to calculate a second estimated polar-domain channel vector of each algorithm sublayer in the LAMP algorithm layer based on the initial linear transformation parameter, the initial nonlinear transformation parameter, the initial linear transformation matrix, and the optimized sensing matrix includes:
for the first algorithm sublayer in the LAMP algorithm layer, calculating a second estimated polar-domain channel vector of the first algorithm sublayer by the initial linear transformation parameter, the initial nonlinear transformation parameter, and the initial linear transformation matrix; and
for the non-first algorithm sublayer in the LAMP algorithm layer, fixing values of linear transformation parameters, nonlinear transformation parameters, and linear transformation matrices of all algorithm sublayers before the current algorithm sublayer, calculating a linear transformation parameter, a nonlinear transformation parameter, and a linear transformation matrix of the current algorithm sublayer based on a linear transformation parameter, a nonlinear transformation parameter, and a linear transformation matrix of the previous algorithm sublayer corresponding to the current algorithm sublayer, and calculating the second estimated polar-domain channel vector of the current algorithm sublayer based on the linear transformation parameter, the nonlinear transformation parameter, and the linear transformation matrix of the current algorithm sublayer.

Further, the compressed sensing-based near-field channel on which estimation is to be performed is reconstructed based on the optimized sparse transformation matrix, the optimized sensing matrix, the optimized linear transformation parameter, the optimized nonlinear transformation parameter, the optimized linear transformation matrix, and the estimate of the compressed sensing-based near-field channel on which estimation is to be performed.

Based on the above method embodiments, the present disclosure correspondingly provides an apparatus embodiment.

The present disclosure provides a compressed sensing-based near-field channel estimation apparatus for XL-MIMO, including:
a channel vector obtaining module and an estimate calculation module, where
the channel vector obtaining module is configured to obtain a channel vector of a compressed sensing-based near-field channel on which estimation is to be performed; and
the estimate calculation module is configured to input the channel vector into a channel estimation model constructed by a deep neural network, such that the channel estimation model converts the channel vector into a polar-domain channel vector by a built-in sparse transformation matrix; compress the polar-domain channel vector into a signal vector by a built-in sensing matrix; add noise to the signal vector, and obtain a received signal vector; input the received signal vector into a built-in LAMP algorithm layer, such that the LAMP algorithm layer performs an iterative calculation on the received signal vector by a built-in soft-thresholding function, and obtain an estimated polar-domain channel vector corresponding to the polar-domain channel vector, where the soft-thresholding function is calculated based on a built-in linear transformation parameter, nonlinear transformation parameter, and linear transformation matrix; and convert, by the built-in sparse transformation matrix, the estimated polar-domain channel vector into an estimate of the compressed sensing-based near-field channel on which estimation is to be performed.

Based on the above method embodiments, the present disclosure correspondingly provides a terminal device embodiment.

The present disclosure provides a terminal device, including: a processor, a memory, and a computer program stored in the memory and configured to be executed by the processor, where the processor executes the computer program to implement the compressed sensing-based near-field channel estimation method for XL-MIMO according to any one of the embodiments of the present disclosure.

Based on the above method embodiments, the present disclosure correspondingly provides a storage medium embodiment.

The present disclosure provides a non-transitory storage medium, including: a processor, a memory, and a computer program stored in the memory and configured to be executed by the processor, where the processor executes the computer program to implement the compressed sensing-based near-field channel estimation method for XL-MIMO according to any one of the embodiments of the present disclosure.

The embodiments of the present disclosure have following beneficial effects:

The present disclosure provides a compressed sensing-based near-field channel estimation method and apparatus for XL-MIMO, a terminal device, and a storage medium. In the above method, a channel vector of a compressed sensing-based near-field channel on which estimation is to be performed is first obtained. Then the channel vector is inputted into a channel estimation model constructed by a deep neural network, such that the channel estimation model converts the channel vector into a polar-domain channel vector by a built-in sparse transformation matrix. Then the polar-domain channel vector is compressed into a signal vector by a built-in sensing matrix. Then noise is added to the signal vector, and a received signal vector is obtained. After that, the received signal vector is inputted into a built-in LAMP algorithm layer, such that the LAMP algorithm layer performs an iterative calculation on the received signal vector by a built-in soft-thresholding function, and an estimated polar-domain channel vector corresponding to the polar-domain channel vector is obtained, where the soft-thresholding function is calculated based on a built-in linear transformation parameter, nonlinear transformation parameter, and linear transformation matrix. Finally, the estimated polar-domain channel vector is converted into an estimate of the compressed sensing-based near-field channel on which estimation is to be performed by the built-in sparse transformation matrix. Therefore, by combining the deep neural network and a LAMP algorithm, the present disclosure can achieve more accurate channel estimation, thereby reducing a quantity of pilot signals required by a system and effectively reducing a pilot overhead.

### BRIEF DESCRIPTION OF THE DRAWINGS

FIG. 1 is a schematic flowchart of a compressed sensing-based near-field channel estimation method for XL-MIMO according to an embodiment of the present disclosure;

FIG. 2 shows an internal structure of a channel estimation model according to an embodiment of the present disclosure;

FIG. 3 schematically shows normalized mean square errors (NMSEs) of a near-field approximate message passing (AMP) algorithm at different stages according to an embodiment of the present disclosure;

FIG. 4 schematically shows NMSEs of the present disclosure, a near-field OMP algorithm, a near-field AMP algorithm, and a near-field LAMP algorithm under different signal-to-noise ratios (SNRs) according to an embodiment of the present disclosure;

FIG. 5 schematically shows NMSEs of the present disclosure, a near-field OMP algorithm, a near-field AMP algorithm, and a near-field LAMP algorithm under different pilot overheads according to an embodiment of the present disclosure; and

FIG. 6 is a schematic structural diagram of a compressed sensing-based near-field channel estimation apparatus for XL-MIMO according to an embodiment of the present disclosure.

### DETAILED DESCRIPTION

The technical solutions in the present disclosure are clearly and completely described below with reference to the accompanying drawings in the present disclosure. Apparently, the described embodiments are only a part rather than all of the embodiments of the present disclosure. All other embodiments obtained by those skilled in the art based on the embodiments of the present disclosure without creative efforts shall fall within the protection scope of the present disclosure.

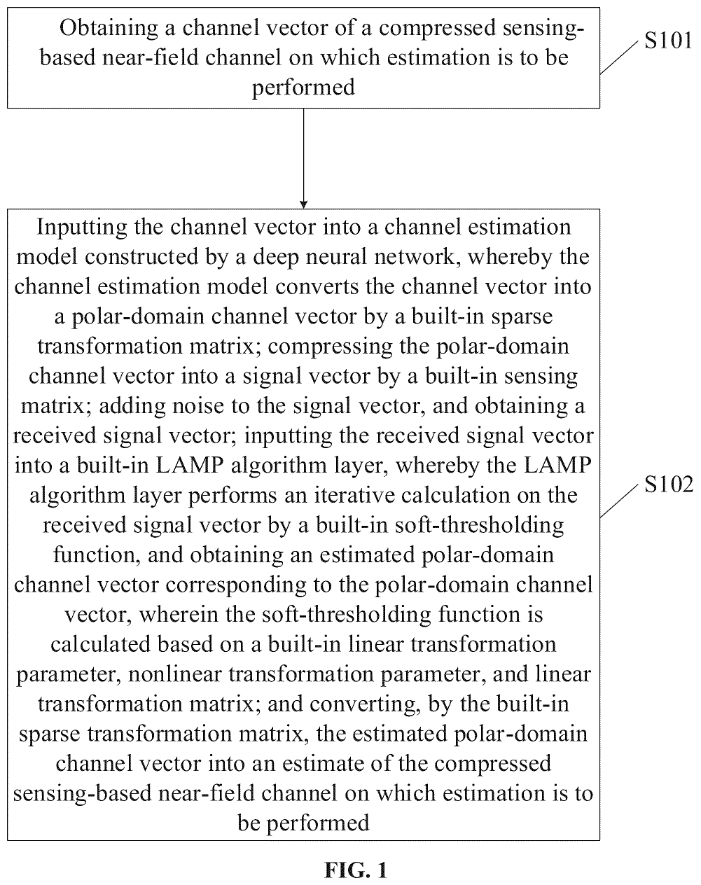

As shown in FIG. 1, a compressed sensing-based near-field channel estimation method for XL-MIMO provided according to an embodiment of the present disclosure includes following steps:
Step S101: Obtain a channel vector of a compressed sensing-based near-field channel on which estimation is to be performed.

Specifically, a uniform linear array is configured for a base station of a downlink XL-MIMO communication system. The uniform linear array contains N antennas with an equal spacing between adjacent antennas, and the equal spacing is half of a carrier wavelength. The channel vector of the compressed sensing-based near-field channel represents a channel vector between a transmitting antenna and a receiving antenna in the uniform linear array.

In this embodiment, as shown in a formula (1), the channel vector of the compressed sensing-based near-field channel on which estimation is to be performed is obtained based on a received signal, a pilot signal of a transmitting antenna of a user, and Gaussian noise:

$$\{ \begin{matrix}y = Ph + n , y , n ∈ {ℂ}^{M \times 1} , P ∈ {ℂ}^{M \times N} \\ h = {[ {h}_{0} , {h}_{1} , … , {h}_{N - 1} ]}^{T}\end{matrix} \qquad ( 1 )$$

In the above formula, y represents the received signal, P represents the pilot signal of the transmitting antenna of the user, n represents the Gaussian noise that follows a CN(0, σ²I_{M}) distribution, h represents the channel vector, M represents a quantity of users, N represents a quantity of base station antennas, and h_{N-1} represents a channel parameter corresponding to an N^{th} base station antenna.

In this embodiment, the channel vector of the compressed sensing-based near-field channel on which estimation is to be performed can be obtained based on the received signal, the pilot signal of the transmitting antenna of the user, and the Gaussian noise.

In a preferred embodiment, when a distance between the base station and a scatterer is within a Rayleigh distance, a channel vector under a spherical wave assumption can be calculated according to a formula (2):

$$\{ \begin{matrix}{δ}_{n} = \frac{2 n - N + 1}{2} ( n = 0 , 1 , … , N - 1 ) \\ {r}_{l}^{( n )} = \sqrt{{r}_{l}^{2} + {δ}_{n}^{2} {d}^{2} - 2 {r}_{l} {δ}_{n} d {θ}_{l}} \\ b ( {θ}_{l} , {r}_{l} ) = {\frac{1}{\sqrt{N}} [ {e}^{- j \frac{2 π}{λ} ( {r}_{l}^{( 0 )} - {r}_{l} ) , … , {e}^{- j \frac{2 π}{λ} ( {r}_{l}^{( N - 1 )} - {r}_{l} )}} ]}^{H} \\ h = \sqrt{\frac{N}{L}} {\sum }_{l = 1}^{L} {α}_{l} b ( {θ}_{l} , {r}_{l} )\end{matrix} \qquad ( 2 )$$

In the above formula, L represents a quantity of scatterer components, αₗ represents a gain of an l^{th} scatterer, θₗ represents an angle of the l^{th} scatterer, rₗ represents a distance from the l^{th} scatterer to a center of the uniform linear array, b(θₗ,rₗ) represents a near-field array steering vector,

$${r}_{l}^{( n )}$$

represents a distance from the l^{th} scatterer to an n^{th} base station antenna, d represents an antenna spacing,

$${δ}_{n} = \frac{2 n - N + 1}{2}$$

represents a temporary variable, and

$${[ {e}^{- j \frac{2 π}{λ} ( {r}_{l}^{( 0 )} - {r}_{l} ) , … , {e}^{- j \frac{2 π}{λ} ( {r}_{l}^{( N - 1 )} - {r}_{l} )}} ]}^{H}$$

represents conjugate transposed of a channel parameter vector from the l^{th} scatterer to each antenna in the uniform linear array.

In this preferred embodiment, the channel vector of the compressed sensing-based near-field channel on which estimation is to be performed when the distance between the base station and the scatterer is within the Rayleigh distance is calculated based on the quantity of scatterer components, a gain and an angle of each scatterer, a distance from each scatterer to the center of the uniform linear array, the near-field array steering vector, a distance from each scatterer to each base station antenna, and the antenna spacing.
Step S102: Input the channel vector into a channel estimation model constructed by a deep neural network, such that the channel estimation model converts the channel vector into a polar-domain channel vector by a built-in sparse transformation matrix; compress the polar-domain channel vector into a signal vector by a built-in sensing matrix; add noise to the signal vector, and obtain a received signal vector; input the received signal vector into a built-in LAMP algorithm layer, such that the LAMP algorithm layer performs an iterative calculation on the received signal vector by a built-in soft-thresholding function, and obtain an estimated polar-domain channel vector corresponding to the polar-domain channel vector, where the soft-thresholding function is calculated based on a built-in linear transformation parameter, nonlinear transformation parameter, and linear transformation matrix; and convert, by the built-in sparse transformation matrix, the estimated polar-domain channel vector into an estimate of the compressed sensing-based near-field channel on which estimation is to be performed.

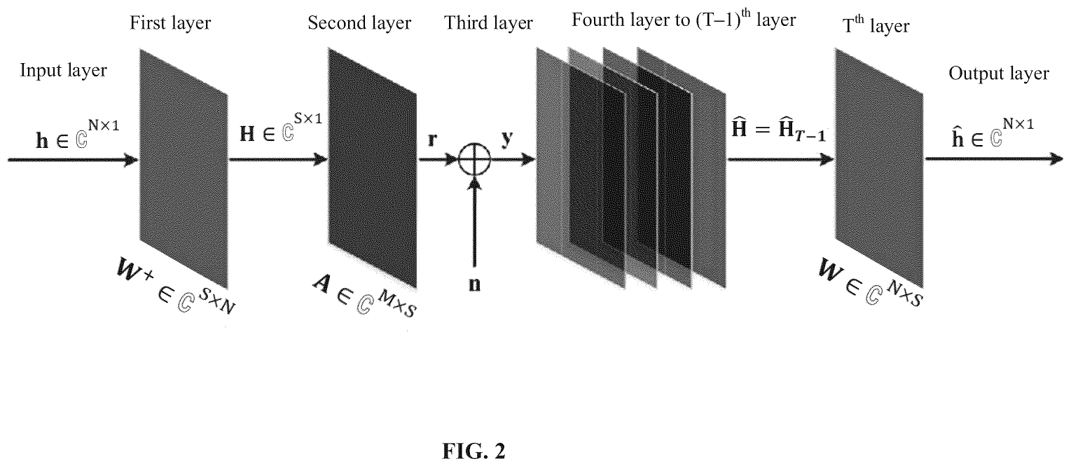

An internal structure of the channel estimation model is schematically shown in FIG. 2. It can be seen that the channel estimation model has a first layer, a second layer, a third layer, . . . , and a T^{th} layer. Parameters of the first layer and the T^{th} layer are sparse transformation matrices, a parameter of the second layer is the sensing matrix, a fourth layer to a (T−1)^{th} layer are collectively referred to as the LAMP algorithm layer, and the fourth layer to the (T−1)^{th} layer are algorithm sublayers of the LAMP algorithm layer.

In a preferred embodiment, the method further includes: training the channel estimation model in two stages. The step of training the channel estimation model in the two stages is performed before the step of inputting the channel vector into the channel estimation model constructed by the deep neural network.

An initial sensing matrix and an initial sparse transformation matrix are adjusted in a first stage based on a first loss function until the first loss function converges.

In another preferred embodiment, the step of adjusting, in the first stage, the initial sensing matrix and the initial sparse transformation matrix based on the first loss function until the first loss function converges is as follows:

A plurality of first channel vectors with a first true label are obtained, and values of the sensing matrix, the sparse transformation matrix, the linear transformation parameter, the nonlinear transformation parameter, and the linear transformation matrix in the to-be-trained channel estimation model are initialized, where the first true label is used to represent a true estimate of each of the first channel vectors.

The first channel vector is inputted into the to-be-trained channel estimation model.

The first channel vector is specifically represented by a formula (3):

$${h}_{1} = {[ {h}_{0} , {h}_{1} , … , {h}_{N - 1} ]}^{T} \qquad ( 3 )$$

The to-be-trained channel estimation model converts the first channel vector into a first polar-domain channel vector by the initial sparse transformation matrix.

The sparse transformation matrix may be specifically represented by a formula (4):

$$W = [ b ( {θ}_{0} , {r}_{0}^{0} ) , … , b ( {θ}_{0} , {r}_{0}^{{S}_{0}} ) , … , b ( {θ}_{N - 1} , {r}_{N - 1}^{0} ) , … , b ( {θ}_{N - 1} , {r}_{N - 1}^{{S}_{N - 1}} ) ] , \\ W ∈ {ℂ}^{N \times S} \qquad ( 4 )$$

In the above formula, Sₙ represents a quantity of distances sampled at an angle θₙ.

The channel vector is converted into the polar-domain channel vector according to a formula (5):

$${h}_{1} = {W}_{1} {H}_{1} , {H}_{1} ∈ {ℂ}^{S \times 1} \qquad ( 5 )$$

In the above formula, H₁ represents the first polar-domain channel vector, W₁ represents the initial sparse transformation matrix, and S represents a total quantity of sampling grids.

The first polar-domain channel vector is compressed into a first signal vector by the initial sensing matrix.

The sensing matrix may be specifically represented by a formula (6):

$${A}_{1} = {PW}_{1} , {A}_{1} ∈ {ℂ}^{M \times S} , P ∈ {ℂ}^{M \times N} \qquad ( 6 )$$

In the above formula, A₁ represents the initial sensing matrix.

Specifically, the polar-domain channel vector is compressed into the signal vector according to a formula (7):

$${r}_{1} = {PW}_{1} {H}_{1} = {A}_{1} {H}_{1} \qquad ( 7 )$$

In the above formula, r₁ represents the signal vector.

First noise is added to the first signal vector, and a first received signal vector is obtained. The first noise is first noise inputted from an external signal.

The received signal vector is specifically obtained according to a formula (8):

$${y}_{1} = {A}_{1} {H}_{1} + {n}_{1} \qquad ( 8 )$$

In the above formula, y₁ represents the first received signal vector, and n₁ represents the first noise.

The first received signal vector is inputted into the built-in LAMP algorithm layer to calculate a final estimated polar-domain channel vector of the LAMP algorithm layer based on an initial linear transformation parameter, an initial nonlinear transformation parameter, an initial linear transformation matrix, and the initial sensing matrix.

In another preferred embodiment, the LAMP algorithm layer contains a plurality of algorithm sublayers.

For a first algorithm sublayer in the LAMP algorithm layer, a first soft-thresholding function of the first algorithm sublayer is calculated by the initial linear transformation parameter, the initial nonlinear transformation parameter, and the initial linear transformation matrix; and a first estimated polar-domain channel vector of the first algorithm sublayer is calculated based on the first soft-thresholding function and the first signal vector.

Specifically, a value of the initial linear transformation parameter is set to 1, and a value of the initial nonlinear transformation parameter is set to 1.1402. The first estimated polar-domain channel vector of the first algorithm sublayer is calculated according to a formula (9):

$$\{ \begin{matrix}{v}_{1}^{′} = {y}_{1} \\ {( {σ}_{1}^{′} )}^{2} = \frac{1}{M} {‖ {v}_{1}^{′} ‖}_{2}^{2} \\ {B}_{1}^{′} = {A}_{1}^{T} \\ {c}_{1}^{′} = {B}_{1}^{′} {v}_{1}^{′} \\ = {η}_{sst} ( {c}_{1}^{′} ; {θ}_{1}^{′} ; {( {σ}_{1}^{′} )}^{2} ) = {θ}_{11}^{′} sign ( {c}_{1}^{′} ) \cdot max ( \vert {c}_{1}^{′} \vert - {θ}_{12}^{′} \cdot {( {σ}_{1}^{′} )}^{2} , 0 )\end{matrix} \qquad ( 9 )$$

In the above formula,

$${v}_{1}^{′}$$

represents a received signal vector of the first algorithm sublayer in the LAMP algorithm layer in the first stage,

$${( {σ}_{1}^{′} )}^{2}$$

represents a nurse vallance of the first algorithm sublayer in the LAMP algorithm layer in the first stage,

$${B}_{1}^{′}$$

represents an initial linear transformation matrix of the first algorithm sublayer in the LAMP algorithm layer in the first stage, [symbol] represents a first estimated polar-domain channel vector in the first stage,

$${θ}_{11}^{′}$$

represents an initial linear transformation parameter of the first algorithm sublayer in the LAMP algorithm layer,

$${θ}_{12}^{′}$$

represents an initial nonlinear transformation parameter of the first algorithm sublayer in the LAMP algorithm layer,

$${η}_{sst} ( {c}_{1}^{′} ; {θ}_{1}^{′} ; {( {σ}_{1}^{′} )}^{2} )$$

represents a first soft-thresholding function in the first stage, and

$${c}_{1}^{′}$$

represents an intermediate variable of the first algorithm sublayer in the LAMP algorithm layer in the first stage.

For a non-first algorithm sublayer in the LAMP algorithm layer, an estimated polar-domain channel vector of a current algorithm sublayer is calculated based on a current sensing matrix, an estimated polar-domain channel vector of a previous algorithm sublayer corresponding to the current algorithm sublayer, and a soft-thresholding function of the previous algorithm sublayer.

Specifically, the linear transformation parameter, the nonlinear transformation parameter, and the linear transformation matrix in the soft-thresholding function are fixedly set to the corresponding initial values in the above first algorithm sublayer. An estimated polar-domain channel vector of the non-first algorithm sublayer in the LAMP algorithm layer is sequentially calculated according to a formula (10):

$$\{ \begin{matrix}{b}_{k}^{′} = \frac{N}{M} 〈 {η}_{sst} ( {c}_{k - 1}^{′} ; {θ}_{1}^{′} , {( {σ}_{k - 1}^{′} )}^{2} ) 〉 \\ {v}_{k}^{′} = {y}_{1} - {A}_{1} {\hat{H}}_{k - 1}^{′} - {b}_{k}^{′} {v}_{k - 1}^{′} \\ {( {σ}_{k}^{′} )}^{2} = \frac{1}{M} {‖ {v}_{k}^{′} ‖}_{2}^{2} \\ {c}_{k}^{′} = {\hat{H}}_{k - 1}^{′} + {B}_{1}^{′} {v}_{k}^{′} \\ = {η}_{sst} ( {c}_{k}^{′} ; {θ}_{1}^{′} , {( {σ}_{k}^{′} )}^{2} ) = {θ}_{11}^{′} sign ( {c}_{k}^{′} ) \cdot max ( \vert {c}_{k}^{′} \vert - {θ}_{12}^{′} \cdot {( {σ}_{k}^{′} )}^{2} , 0 )\end{matrix} \qquad ( 10 )$$

In the above formula,

$${b}_{k}^{′}$$

represents an offset of a k^{th} algorithm sublayer in the LAMP algorithm layer in the first stage,

$${v}_{k}^{′}$$

represents an updated received signal vector of the k^{th}algorithm sublayer in the LAMP algorithm layer in the first stage,

$${( {σ}_{k - 1}^{′} )}^{2}$$

variance of a (k−1)^{th} algorithm sublayer in the first stage,

$${( {σ}_{k}^{′} )}^{2}$$

represents a noise variance of the k^{th} algorithm sublayer in the first stage,

$${c}_{k}^{′}$$

represents an intermediate variable of the k^{th} algorithm sublayer in the LAMP algorithm layer in the first stage,

$${\hat{H}}_{k - 1}^{′}$$

represents an estimated polar-domain channel vector of the (k−1)^{th} algorithm sublayer in the LAMP algorithm layer in the first stage, [symbol] represents an estimated polar-domain channel vector of the k^{th} algorithm sublayer in the LAMP algorithm layer in the first stage, and

$${η}_{sst} ( {c}_{k}^{′} ; {θ}_{1}^{′} , {( {σ}_{k}^{′} )}^{2} )$$

represents a sort-thresholding function of the k^{th} algorithm sublayer in the LAMP algorithm layer in the first stage.

The final estimated polar-domain channel vector of the LAMP algorithm layer is calculated based on estimated polar-domain channel vectors of all the algorithm sublayers in the LAMP algorithm layer.

Specifically, an estimated polar-domain channel vector of a last algorithm sublayer in the LAMP algorithm layer will be used as the estimated polar-domain channel vector corresponding to the polar-domain channel vector.

A first estimate corresponding to the first channel vector is obtained based on the initial sparse transformation matrix and the final estimated polar-domain channel vector.

Specifically, the estimated polar-domain channel vector is converted into a first estimate of the compressed sensing-based near-field channel on which estimation is to be performed according to a formula (11):

$$= {W}_{1} = {[ \overline{{h}_{0}} , \overline{{h}_{1}} , … , \overline{{h}_{N - 1}} ]}^{T} \qquad ( 11 )$$

In the above formula, [symbol] represents the first estimate.

A value of the first loss function is calculated based on the first channel vector, the first estimate, and a formula of the first loss function.

Specifically, the value of the first loss function is calculated according to a formula (12):

$${ℒ}_{1} = min ( {\sum }_{n = 0}^{N - 1} {\vert {h}_{n} - {\overline{h}}_{n} \vert}^{2} ) \qquad ( 12 )$$

In the above formula, [symbol] represents the value of the first loss function.

After one value of the first loss function is calculated each time, whether the first loss function converges currently is determined; and if the first loss function does not converge currently, the value of the sensing matrix and the value of the sparse transformation matrix are adjusted, and the to-be-trained channel estimation model is continuously trained; or if the first loss function converges currently, it is determined that the training of the to-be-trained channel estimation model in the first stage has been completed, and an optimized sensing matrix and an optimized sparse transformation matrix are obtained.

Preferably, through the training in the first stage, the optimized sparse transformation matrix and the optimized sensing matrix better match a complex characteristic of a near-field channel. In addition, an approximation error of a polar-domain transformation matrix on the sensing matrix is reduced, a conversion error between different channel domains is suppressed, and tolerance for sparsity of a polar-domain channel is improved.

The initial linear transformation parameter, the initial nonlinear transformation parameter, and the initial linear transformation matrix are adjusted in the second stage based on a second loss function until the second loss function converges.

In a preferred embodiment, the step of adjusting, in the second stage, the initial linear transformation parameter, the initial nonlinear transformation parameter, and the initial linear transformation matrix based on the second loss function until the second loss function converges is as follows:

A plurality of second channel vectors with a second true label are obtained, where the second true label is used to represent a true estimate of each of the second channel vectors.

The second channel vector is specifically represented by a formula (13):

$${h}_{2} = {[ {h}_{0} , {h}_{1} , … , {h}_{N - 1} ]}^{T} \qquad ( 13 )$$

In the above formula, h₂ represents the second channel vector.

The second channel vector is inputted into the channel estimation model in the second stage.

The to-be-trained channel estimation model converts the second channel vector into a second polar-domain channel vector by the optimized sparse transformation matrix.

Specifically, the second channel vector is converted into the second polar-domain channel vector according to a formula (14):

$${h}_{2} = {WH}_{2} \qquad ( 14 )$$

In the above formula, W represents the optimized sparse transformation matrix, and H₂ represents the second polar-domain channel vector.

The second polar-domain channel vector is compressed into a second signal vector by the optimized sensing matrix.

Specifically, the second polar-domain channel vector is compressed into the second signal vector according to a formula (15):

$$\{ \begin{matrix}A = PW , A ∈ {ℂ}^{M \times S} P ∈ {ℂ}^{M \times N} \\ {r}_{2} = {PWH}_{2} = A {H}_{2}\end{matrix} \qquad ( 15 )$$

In the above formula, A represents the optimized sensing matrix, and r₂ represents the second signal vector.

Second noise is added to the second signal vector, and a second received signal vector is obtained. The second noise is second noise inputted from an external signal.

The second received signal vector is specifically obtained according to a formula (16):

$${y}_{2} = A {H}_{2} + {n}_{2} \qquad ( 16 )$$

In the above formula, y₂ represents the second received signal vector, and n₂ represents the second noise.

The second received signal vector is inputted into the built-in LAMP algorithm layer to calculate a second estimated polar-domain channel vector of each algorithm sublayer in the LAMP algorithm layer based on the initial linear transformation parameter, the initial nonlinear transformation parameter, the initial linear transformation matrix, and the optimized sensing matrix.

Preferably, the step of inputting the second received signal vector into the built-in LAMP algorithm layer to calculate the estimated polar-domain channel vector of each algorithm sublayer in the LAMP algorithm layer based on the initial linear transformation parameter, the initial nonlinear transformation parameter, the initial linear transformation matrix, and the optimized sensing matrix is as follows:

For the first algorithm sublayer in the LAMP algorithm layer, a second estimated polar-domain channel vector of the first algorithm sublayer is calculated by the initial linear transformation parameter, the initial nonlinear transformation parameter, and the initial linear transformation matrix.

Specifically, the second estimated polar-domain channel vector of the first algorithm sublayer is calculated according to a formula (17):

$$\{ \begin{matrix}{v}_{1}^{″} = {y}_{2} \\ {( {σ}_{1}^{″} )}^{2} = \frac{1}{M} {‖ {v}_{1}^{″} ‖}_{2}^{2} \\ {B}_{1}^{″} = {A}_{1}^{T} \\ {c}_{1}^{″} = {B}_{1}^{″} {v}_{1}^{′} \\ {\hat{H}}_{1}^{″} = {η}_{s s t} ( {c}_{1}^{″} ; {θ}_{1}^{″} ; {( {σ}_{1}^{″} )}^{2} ) = {θ}_{11}^{″} sign ( {c}_{1}^{″} ) \cdot max ( \vert {c}_{1}^{″} \vert - {θ}_{12}^{″} \cdot {( {σ}_{1}^{″} )}^{2} , 0 )\end{matrix} \qquad ( 17 )$$

In the above formula, y₂ represents a second received signal vector,

$${v}_{1}^{″}$$

represents a received signal vector of the first algorithm sublayer in the LAMP algorithm layer in the second stage,

$${( {σ}_{1}^{″} )}^{2}$$

represents a noise variance of the first algorithm sublayer in the LAMP algorithm layer in the second stage,

$${c}_{1}^{″}$$

presents an intermediate variable of the first algorithm sublayer in the LAMP algorithm layer in the second stage,

$${B}_{1}^{″}$$

represents a linear transformation matrix of the first algorithm sublayer in the LAMP algorithm layer in the second stage, [symbol] represents a second estimated polar-domain channel vector in the second stage,

$${θ}_{1}^{″}$$

represents a linear transformation parameter and a nonlinear transformation parameter of the first algorithm sublayer in the LAMP algorithm layer in the second stage,

$${θ}_{11}^{″}$$

represents the linear transformation parameter of the first algorithm sublayer in the LAMP algorithm layer in the second stage, and

$${θ}_{12}^{″}$$

represents the nonlinear transformation parameter of the first algorithm sublayer in the LAMP algorithm layer in the second stage.

For the non-first algorithm sublayer in the LAMP algorithm layer, values of linear transformation parameters, nonlinear transformation parameters, and linear transformation matrices of all algorithm sublayers before the current algorithm sublayer are fixed, a linear transformation parameter, a nonlinear transformation parameter, and a linear transformation matrix of the current algorithm sublayer are calculated based on a linear transformation parameter, a nonlinear transformation parameter, and a linear transformation matrix of the previous algorithm sublayer corresponding to the current algorithm sublayer, and an second estimated polar-domain channel vector of the current algorithm layer is calculated based on the linear transformation parameter, the nonlinear transformation parameter, and the linear transformation matrix of the current algorithm sublayer.

Specifically, the second estimated polar-domain channel vector of the current algorithm sublayer is calculated according to a formula (18):

$$\{ \begin{matrix}{θ}_{k}^{″} = {θ}_{k - 1}^{″} \\ {b}_{k}^{″} = \frac{N}{M} 〈 {η}_{s s t} ( {c}_{k - 1}^{″} ; {θ}_{k}^{″} , {( {σ}_{k - 1}^{″} )}^{2} ) 〉 \\ {v}_{k}^{″} = {y}_{2} - A {\hat{H}}_{k - 1}^{″} - {b}_{k}^{″} {v}_{k - 1}^{″} \\ {( {σ}_{k}^{″} )}^{2} = \frac{1}{M} {‖ {v}_{k}^{l l} ‖}_{2}^{2} \\ {B}_{k}^{″} = {B}_{k - 1}^{″} \\ {c}_{k}^{″} = {\hat{H}}_{k - 1}^{″} + {B}_{k}^{″} {v}_{k}^{″} \\ {\hat{H}}_{1}^{″} = {η}_{s s t} ( {c}_{1}^{″} ; {θ}_{1}^{″} ; {( {σ}_{1}^{″} )}^{2} ) = {θ}_{11}^{″} sign ( {c}_{1}^{″} ) \cdot max ( \vert {c}_{1}^{″} \vert - {θ}_{12}^{″} \cdot {( {σ}_{1}^{″} )}^{2} , 0 )\end{matrix} \qquad ( 18 )$$

In the above formula,

$${b}_{k}^{″}$$

an offset of the kth algorithm sublayer in the LAMP algorithm layer in the second stage,

$${θ}_{k}^{′′}$$

represents a linear transformation parameter and a nonlinear transformation parameter of the kth algorithm sublayer in the LAMP algorithm layer in the second stage,

$${c}_{k}^{′′}$$

represents an intermediate variable of the k^{th} algorithm sublayer in the LAMP algorithm layer in the second stage,

$${\hat{H}}_{k}^{′′}$$

represents a second estimated polar-domain channel vector of the kth algorithm sublayer in the LAMP algorithm layer in the second stage,

$${θ}_{k 1}^{′′}$$

represents the linear transformation parameter of the k^{th} algorithm sublayer in the LAMP algorithm layer in the second stage, and

$${θ}_{k 2}^{′′}$$

represents the nonlinear transformation parameter of the k^{th} algorithm sublayer in the LAMP algorithm layer in the second stage.

A second estimate of each algorithm sublayer is obtained based on the optimized sparse transformation matrix and the second estimated polar-domain channel vector of each algorithm sublayer.

Specifically, the second estimate of each algorithm sublayer is calculated according to a formula (19):

$$= W {\hat{H}}_{k}^{′′} = {[ {\overline{\overline{h}}}_{k}^{0} , {\overline{\overline{h}}}_{k}^{1} , ⋯ , {\overline{\overline{h}}}_{k}^{N - 1} ]}^{T} \qquad ( 19 )$$

In the above formula, [symbol] represents the second estimate.

After a second estimate of an algorithm sublayer is calculated each time, a value of a second loss function of the algorithm sublayer is calculated based on the second channel vector, the second estimate, and a formula of the second loss function.

Specifically, the value of the second loss function of the algorithm sublayer is calculated according to a formula (20):

$${ℒ}_{2} = min ( {\sum }_{n = 0}^{N - 1} {\vert {h}_{n} - {\overline{\overline{h}}}_{k}^{n} \vert}^{2} ) \qquad ( 20 )$$

In the above formula, [symbol] represents the value of the second loss function.

After one value of the second loss function is calculated each time, whether a second loss function of a current algorithm sublayer converges is determined. If the second loss function of the current algorithm sublayer does not converge, a linear transformation parameter, a nonlinear transformation parameter, and a linear transformation matrix of a previous algorithm sublayer corresponding to the current algorithm sublayer are fixed, a linear transformation parameter, a nonlinear transformation parameter, and a linear transformation matrix of the current algorithm sublayer are adjusted, and the to-be-trained channel estimation model is continuously trained. If the second loss function of the current algorithm sublayer converges, it is determined that the training of the to-be-trained channel estimation model in the second stage has been completed, and an optimized linear transformation parameter, an optimized nonlinear transformation parameter, and an optimized linear transformation matrix are obtained.

Preferably, the optimized sensing matrix and the optimized sparse transformation matrix are used to optimize a linear transformation parameter, a nonlinear transformation parameter and a linear transformation matrix in the LAMP algorithm layer, improving meticulousness and superiority of the system. In this way, the two-stage model training can meet a strict restricted isometry property (RIP) requirement of AMP.

Specifically, the built-in sparse transformation matrix is the optimized sparse transformation matrix.

In a preferred embodiment, the channel vector is converted into the polar-domain channel vector according to a formula (21):

$$h = WH , H ∈ {ℂ}^{S \times 1} \qquad ( 21 )$$

In the above formula, H represents the polar-domain channel vector, and S represents the total quantity of sampling grids.

In this embodiment, the channel vector is converted into the polar-domain channel vector by a parameter in the first layer of the channel estimation model, namely, the optimized sparse transformation matrix.

Specifically, the built-in sensing matrix is the optimized sensing matrix, and the sensing matrix is the parameter of the second layer in the channel estimation model.

The sensing matrix may be specifically represented by a formula (22):

$$A = PW , A ∈ {ℂ}^{M \times S} \qquad ( 22 )$$

In a preferred embodiment, the polar-domain channel vector is compression into the signal vector according to a formula (23):

$$r = PWH = AH \qquad ( 23 )$$

In the above formula, r represents the signal vector.

In this preferred embodiment, the channel vector is converted into the polar-domain channel vector by the parameter of the first layer in the channel estimation model, namely, the sparse transformation matrix.

In a preferred embodiment, the received signal vector is obtained according to a formula (24):

$$y = AH + n \qquad ( 24 )$$

In the above formula, y represents the received signal vector.

In this preferred embodiment, noise is added to the third layer in the channel estimation model, and the received signal vector is obtained. The noise is noise inputted from an external signal.

Specifically, the above built-in linear transformation parameter, nonlinear transformation parameter, and linear transformation matrix are respectively the optimized linear transformation parameter, optimized nonlinear transformation parameter, and optimized linear transformation matrix.

In a preferred embodiment, an estimated polar-domain channel vector of the first algorithm sublayer in the LAMP algorithm layer is calculated according to a formula (25):

$$\{ \begin{matrix}{v}_{1} = y \\ {σ}_{1}^{2} = \frac{1}{M} {‖ {v}_{1} ‖}_{2}^{2} \\ {c}_{1} = {Bv}_{1} \\ {\hat{H}}_{1} = {η}_{sst} ( {c}_{1} ; {θ}_{1} ; {σ}_{1}^{2} ) = {θ}_{11} sign ( {c}_{1} ) \cdot max ( \vert {c}_{1} \vert - {θ}_{12} \cdot {σ}_{1}^{2} , 0 )\end{matrix} \qquad ( 25 )$$

In the above formula, v₁ represents a received signal vector of the first algorithm sublayer in the LAMP algorithm layer,

$${σ}_{1}^{2}$$

represents a noise variance of the first layer, c₁ represents an intermediate variable of the first algorithm sublayer, B represents the optimized linear transformation matrix, Ĥ₁ represents an estimated polar-domain channel vector that is of the first algorithm sublayer and corresponds to the polar-domain channel vector, θ₁₁ represents the optimized linear transformation parameter, θ₁₂ represents the optimized nonlinear transformation parameter, and ηₛₛₜ represents the soft-thresholding function.

The estimated polar-domain channel vector of the non-first algorithm sublayer in the LAMP algorithm layer is sequentially calculated according to a formula (26), and the estimated polar-domain channel vector of the last algorithm sublayer in the LAMP algorithm layer will be used as the estimated polar-domain channel vector corresponding to the polar-domain channel vector.

$$\{ \begin{matrix}{b}_{k} = \frac{N}{M} 〈 {η}_{sst}^{′} ( {c}_{k - 1} ; {θ}_{1} , {σ}_{k - 1}^{2} ) 〉 \\ {v}_{k} = y - A {\hat{H}}_{k - 1} - {b}_{k} {v}_{k - 1} \\ {σ}_{k}^{2} = \frac{1}{M} {‖ {v}_{k} ‖}_{2}^{2} \\ {c}_{k} = {\hat{H}}_{k - 1} + {Bv}_{k} \\ {\hat{H}}_{1} = {η}_{sst} ( {c}_{k} ; {θ}_{1} ; {σ}_{k}^{2} ) = {θ}_{11} sign ( {c}_{k} ) \cdot max ( \vert {c}_{k} \vert - {θ}_{12} \cdot {σ}_{k}^{2} , 0 )\end{matrix} \qquad ( 26 )$$

In this preferred embodiment, the estimated polar-domain channel vector corresponding to the polar-domain channel vector is iteratively calculated by the built-in soft-thresholding function.

Specifically, the built-in sparse transformation matrix is the optimized sparse transformation matrix.

In a preferred embodiment, the estimated polar-domain channel vector is converted into the estimate of the compressed sensing-based near-field channel on which estimation is to be performed according to a formula (27):

$$\hat{h} = W \qquad ( 27 )$$

In the above formula, ĥ represents the estimate.

In this preferred embodiment, the estimated polar-domain channel vector is converted into the estimate of the compressed sensing-based near-field channel on which estimation is to be performed by the optimized sparse transformation matrix.

In another preferred embodiment, the compressed sensing-based near-field channel on which estimation is to be performed is reconstructed based on the optimized sparse transformation matrix, the optimized sensing matrix, the optimized linear transformation parameter, the optimized nonlinear transformation parameter, the optimized linear transformation matrix, and the estimate of the compressed sensing-based near-field channel on which estimation is to be performed.

Preferably, a reconstructed compressed sensing-based near-field channel can be used for subsequent signal detection and related data monitoring.

In this preferred embodiment, the compressed sensing-based near-field channel on which estimation is to be performed is reconstructed based on the optimized sparse transformation matrix, the optimized sensing matrix, the optimized linear transformation parameter, the optimized nonlinear transformation parameter, the optimized linear transformation matrix, and the estimate of the compressed sensing-based near-field channel on which estimation is to be performed.

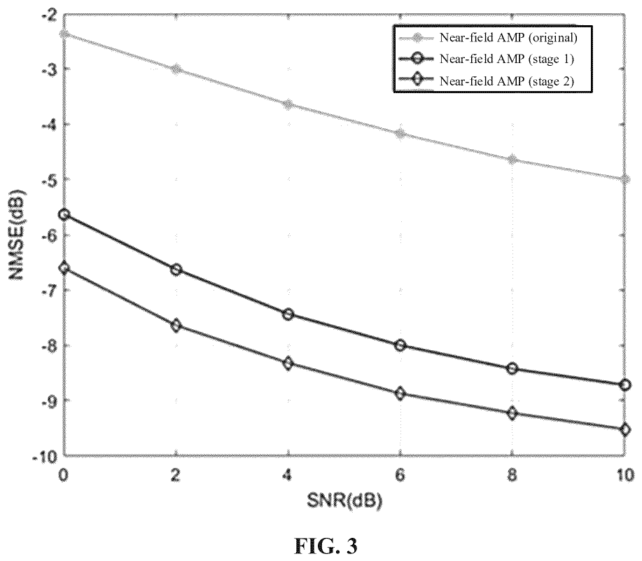

Schematically, as shown in FIG. 3, through the first-stage and second-stage optimization processes, an error of a channel estimation result due to an increase in an SNR of an original signal is greatly reduced. This design not only achieves performance improvement, but also prevents an adverse local optimum.

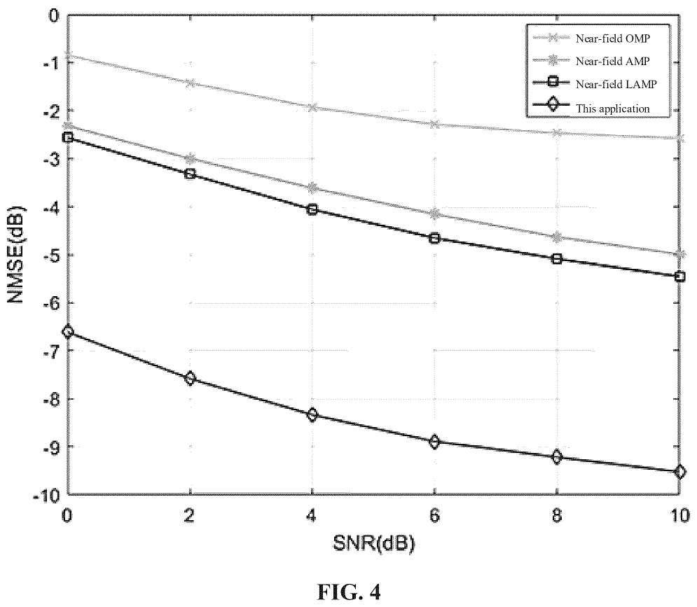

Schematically, as shown in FIG. 4, in all considered SNR regions, the scheme proposed in the present disclosure has a lower error than other three existing schemes. In addition, due to the optimization of the sensing matrix and the sparse transformation matrix in the first stage, a characteristic of the near-field channel is effectively captured, and an adverse effect of channel sparsity approximation is reduced. This ensures that the proposed scheme can achieve higher channel estimation accuracy.

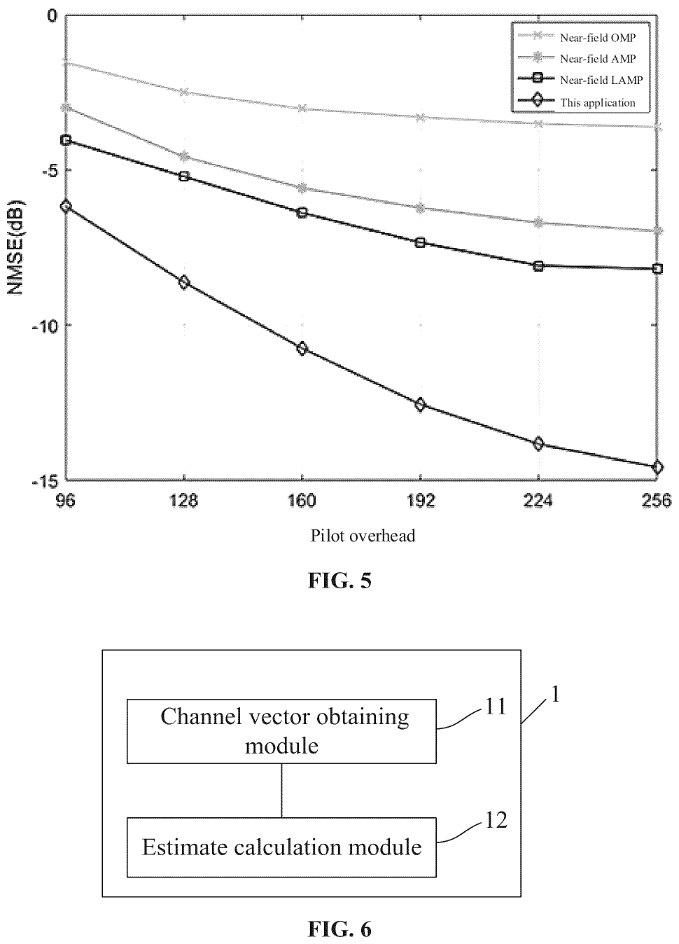

Schematically, as shown in FIG. 5, SNR=8 dB, a pilot overhead increases from 96 to 256, and a corresponding compression ratio increases from 0.375 to 1. Within a range shown in FIG. 5, the optimization scheme proposed in the present disclosure achieves same channel estimation accuracy as other schemes while reducing the pilot overhead. In particular, the LAMP scheme requires an overhead of approximately 224 pilots to achieve an NMSE of-7 dB, while the scheme proposed in the present disclosure only requires approximately 128 pilots.

Based on the above method embodiments, the present disclosure correspondingly provides an apparatus embodiment.

As shown in FIG. 6, an embodiment of the present disclosure provides a compressed sensing-based near-field channel estimation apparatus 1 for XL-MIMO, including: a channel vector obtaining module 11 and an estimate calculation module 12.

The channel vector obtaining module 11 is configured to obtain a channel vector of a compressed sensing-based near-field channel on which estimation is to be performed.

The estimate calculation module 12 is configured to: input the channel vector into a channel estimation model constructed by a deep neural network, such that the channel estimation model converts the channel vector into a polar-domain channel vector by a built-in sparse transformation matrix; compress the polar-domain channel vector into a signal vector by a built-in sensing matrix; add noise to the signal vector, and obtain a received signal vector; input the received signal vector into a built-in LAMP algorithm layer, such that the LAMP algorithm layer performs an iterative calculation on the received signal vector by a built-in soft-thresholding function, and obtain an estimated polar-domain channel vector corresponding to the polar-domain channel vector, where the soft-thresholding function is calculated based on a built-in linear transformation parameter, nonlinear transformation parameter, and linear transformation matrix; and convert, by the built-in sparse transformation matrix, the estimated polar-domain channel vector into an estimate of the compressed sensing-based near-field channel on which estimation is to be performed.

In this embodiment of the present disclosure, the channel vector obtaining module 11 and the estimate calculation module 12 each may be at least one controller that has a communication interface, can realize a communication protocol, and may further include a memory, a related interface and system transmission bus, and the like if necessary. The controller executes program-related code to realize a corresponding function.

It should be noted that the apparatus embodiment described above is merely illustrative, where the module described as a separate component may or may not be physically separated, and a component displayed as a module may or may not be a physical module, that is, the component may be located at one place, or distributed on a plurality of network units. Some or all of the modules may be selected based on actual needs to achieve the objectives of the solutions of the embodiments. In addition, in the accompanying drawing of the apparatus embodiment provided in the present disclosure, a connection relationship between modules represents a communication connection between the modules, which may be specifically implemented as at least one communication bus or signal line. Those of ordinary skill in the art can understand and implement the embodiments without creative effort. The schematic diagram shows only an example of the compressed sensing-based near-field channel estimation apparatus for XL-MIMO, does not constitute a limitation on the compressed sensing-based near-field channel estimation apparatus for XL-MIMO, and may include more or less components than those shown in the figure, a combination of some components, or different components.

Based on the above method embodiments, the present disclosure correspondingly provides a terminal device embodiment.

Another embodiment of the present disclosure provides a terminal device, including: a processor, a memory, and a computer program stored in the memory and configured to be executed by the processor. The processor executes the computer program to implement the compressed sensing-based near-field channel estimation method for XL-MIMO in any one of the embodiments of the present disclosure.

For example, in this embodiment, the computer program may be divided into at least one module. The at least one module is stored in the memory and executed by the processor to complete the present disclosure. The at least one module may be a series of computer program instruction segments capable of implementing specific functions, and the instruction segments are used for describing an execution process of the computer program in the terminal device.

The terminal device may be a computing device such as a desktop computer, a notebook, a palmtop computer, or a cloud server. The terminal device may include, but not be limited to, the processor and the memory.

The processor may be a central processing module, CPU), and may also be another general-purpose processor, a digital signal processor (DSP), an application specific integrated circuit (ASIC), a field-programmable gate array (FPGA) or another programmable logic device, a discrete gate or transistor logic device, a discrete hardware component, or the like. The general-purpose processor may be a microprocessor, any conventional processor, or the like. The processor is a control center of the terminal device, and connects to various parts of the terminal device by various interfaces and lines.

The memory may be configured to store the above computer program and/or modules. The processor implements various functions of the terminal device by running or executing the computer program and/or modules stored in the memory and invoking data stored in the memory. The memory may mainly include a program storage area and a data storage area. The program storage area may store an operating system, an application program required by at least one function, and the like. In addition, the memory may include a high-speed random access memory, and may further include a non-transitory memory, such as a hard disk, an internal storage, a plug-in hard disk, a smart media card (SMC), a secure digital (SD) card, a flash card, at least one magnetic disk storage device, a flash memory device, or another volatile solid-state storage device.

Based on the above method embodiments, the present disclosure correspondingly provides a storage medium embodiment.

Another embodiment of the present disclosure provides a non-transitory storage medium. The non-transitory storage medium includes a stored computer program, and the computer program is run to control a device on which the non-transitory storage medium is located to perform the compressed sensing-based near-field channel estimation method for XL-MIMO in any one of the embodiments of the present disclosure.

In this embodiment, the non-transitory storage medium is a computer-readable storage medium. The computer program includes computer program code, and the computer program code may be in a form of source code, object code, or an executable file, may be in some intermediate forms, or the like. The computer-readable storage medium may include: any physical entity or apparatus capable of carrying the computer program code, a recording medium, a universal serial bus (USB) disk, a mobile hard disk drive, a magnetic disk, an optical disc, a computer memory, a read-only memory (ROM), a random access memory (RAM), an electrical carrier signal, a telecommunications signal, a software distribution medium, and the like.

Compared with the prior art, the above embodiments of the present disclosure can reduce a pilot overhead for near-field channel estimation.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1. A compressed sensing-based near-field channel estimation method for extra-large-scale massive multiple-input multiple-output (XL-MIMO), comprising:
obtaining a channel vector of a compressed sensing-based near-field channel on which estimation is to be performed; and
inputting the channel vector into a channel estimation model constructed by a deep neural network, whereby the channel estimation model converts the channel vector into a polar-domain channel vector by a built-in sparse transformation matrix; compressing the polar-domain channel vector into a signal vector by a built-in sensing matrix; adding noise to the signal vector, and obtaining a received signal vector; inputting the received signal vector into a built-in learned approximate message passing (LAMP) algorithm layer, whereby the LAMP algorithm layer performs an iterative calculation on the received signal vector by a built-in soft-thresholding function, and obtaining an estimated polar-domain channel vector corresponding to the polar-domain channel vector, wherein the soft-thresholding function is calculated based on a built-in linear transformation parameter, nonlinear transformation parameter, and linear transformation matrix; and converting, by the built-in sparse transformation matrix, the estimated polar-domain channel vector into an estimate of the compressed sensing-based near-field channel on which estimation is to be performed.

2. The compressed sensing-based near-field channel estimation method for XL-MIMO according to claim 1, further comprising: training the channel estimation model in two stages:
adjusting, in a first stage, an initial sensing matrix and an initial sparse transformation matrix based on a first loss function until the first loss function converges; and
adjusting, in a second stage, an initial linear transformation parameter, an initial nonlinear transformation parameter, and an initial linear transformation matrix based on a second loss function until the second loss function converges.

3. The compressed sensing-based near-field channel estimation method for XL-MIMO according to claim 2, wherein the adjusting, in a first stage, an initial sensing matrix and an initial sparse transformation matrix based on a first loss function until the first loss function converges comprises:
obtaining a plurality of first channel vectors with a first true label, and initializing values of the sensing matrix, the sparse transformation matrix, the linear transformation parameter, the nonlinear transformation parameter, and the linear transformation matrix in the to-be-trained channel estimation model, wherein the first true label is used to represent a true estimate of each of the first channel vectors;
inputting the first channel vector into the to-be-trained channel estimation model;
converting, by the to-be-trained channel estimation model, the first channel vector into a first polar-domain channel vector through the initial sparse transformation matrix;
compressing the first polar-domain channel vector into a first signal vector by the initial sensing matrix;
adding first noise to the first signal vector, and obtaining a first received signal vector;
inputting the first received signal vector into the built-in LAMP algorithm layer to calculate a final estimated polar-domain channel vector of the LAMP algorithm layer based on the initial linear transformation parameter, the initial nonlinear transformation parameter, the initial linear transformation matrix, and the initial sensing matrix;
obtaining, based on the initial sparse transformation matrix and the final estimated polar-domain channel vector, a first estimate corresponding to the first channel vector;
calculating a value of the first loss function based on the first channel vector, the first estimate, and a formula of the first loss function; and
after calculating one value of the first loss function each time, determining whether the first loss function converges currently; and if the first loss function does not converge currently, adjusting the value of the sensing matrix and the value of the sparse transformation matrix, and continuously training the to-be-trained channel estimation model; or if the first loss function converges currently, determining that the training of the to-be-trained channel estimation model in the first stage has been completed, and obtaining an optimized sensing matrix and an optimized sparse transformation matrix.

4. The compressed sensing-based near-field channel estimation method for XL-MIMO according to claim 3, wherein the LAMP algorithm layer contains a plurality of algorithm sublayers;
for a first algorithm sublayer in the LAMP algorithm layer, a first soft-thresholding function of the first algorithm sublayer is calculated by the initial linear transformation parameter, the initial nonlinear transformation parameter, and the initial linear transformation matrix; and a first estimated polar-domain channel vector of the first algorithm sublayer is calculated based on the first soft-thresholding function and the first signal vector;
for a non-first algorithm sublayer in the LAMP algorithm layer, an estimated polar-domain channel vector of a current algorithm sublayer is calculated based on a current sensing matrix, an estimated polar-domain channel vector of a previous algorithm sublayer corresponding to the current algorithm sublayer, and a soft-thresholding function of the previous algorithm sublayer; and
the final estimated polar-domain channel vector of the LAMP algorithm layer is calculated based on estimated polar-domain channel vectors of all the algorithm sublayers in the LAMP algorithm layer.

5. The compressed sensing-based near-field channel estimation method for XL-MIMO according to claim 4, wherein the adjusting, in a second stage, an initial linear transformation parameter, an initial nonlinear transformation parameter, and an initial linear transformation matrix based on a second loss function until the second loss function converges comprises:
obtaining a plurality of second channel vectors with a second true label, wherein the second true label is used to represent a true estimate of each of the second channel vectors;
inputting the second channel vector into the channel estimation model in the second stage;
converting, by the to-be-trained channel estimation model, the second channel vector into a second polar-domain channel vector through the optimized sparse transformation matrix;
compressing the second polar-domain channel vector into a second signal vector by the optimized sensing matrix;
adding second noise to the second signal vector, and obtaining a second received signal vector;
inputting the second received signal vector into the built-in LAMP algorithm layer to calculate a second estimated polar-domain channel vector of each algorithm sublayer in the LAMP algorithm layer based on the initial linear transformation parameter, the initial nonlinear transformation parameter, the initial linear transformation matrix, and the optimized sensing matrix;
obtaining a second estimate of each algorithm sublayer based on the optimized sparse transformation matrix and the second estimated polar-domain channel vector of each algorithm sublayer;
after calculating a second estimate of an algorithm sublayer each time, calculating a value of a second loss function of the algorithm sublayer based on the second channel vector, the second estimate, and a formula of the second loss function; and
after calculating one value of the second loss function each time, determining whether a second loss function of a current algorithm sublayer converges; and if the second loss function of the current algorithm sublayer does not converge, fixing a linear transformation parameter, a nonlinear transformation parameter, and a linear transformation matrix of a previous algorithm sublayer corresponding to the current algorithm sublayer, adjusting a linear transformation parameter, a nonlinear transformation parameter, and a linear transformation matrix of the current algorithm sublayer, and continuously training the to-be-trained channel estimation model; or if the second loss function of the current algorithm sublayer converges, determining that the training of the to-be-trained channel estimation model in the second stage has been completed, and obtaining an optimized linear transformation parameter, an optimized nonlinear transformation parameter, and an optimized linear transformation matrix.

6. The compressed sensing-based near-field channel estimation method for XL-MIMO according to claim 5, wherein the inputting the second received signal vector into the built-in LAMP algorithm layer to calculate a second estimated polar-domain channel vector of each algorithm sublayer in the LAMP algorithm layer based on the initial linear transformation parameter, the initial nonlinear transformation parameter, the initial linear transformation matrix, and the optimized sensing matrix comprises:
for the first algorithm sublayer in the LAMP algorithm layer, calculating a second estimated polar-domain channel vector of the first algorithm sublayer by the initial linear transformation parameter, the initial nonlinear transformation parameter, and the initial linear transformation matrix; and
for the non-first algorithm sublayer in the LAMP algorithm layer, fixing values of linear transformation parameters, nonlinear transformation parameters, and linear transformation matrices of all algorithm sublayers before the current algorithm sublayer, calculating a linear transformation parameter, a nonlinear transformation parameter, and a linear transformation matrix of the current algorithm sublayer based on a linear transformation parameter, a nonlinear transformation parameter, and a linear transformation matrix of the previous algorithm sublayer corresponding to the current algorithm sublayer, and calculating the second estimated polar-domain channel vector of the current algorithm sublayer based on the linear transformation parameter, the nonlinear transformation parameter, and the linear transformation matrix of the current algorithm sublayer.

7. The compressed sensing-based near-field channel estimation method for XL-MIMO according to claim 6, further comprising:
based on the optimized sparse transformation matrix, the optimized sensing matrix, the optimized linear transformation parameter, the optimized nonlinear transformation parameter, the optimized linear transformation matrix, and the estimate of the compressed sensing-based near-field channel on which estimation is to be performed, reconstructing the compressed sensing-based near-field channel on which estimation is to be performed.

8. A compressed sensing-based near-field channel estimation apparatus for XL-MIMO, comprising:
a channel vector obtaining module and an estimate calculation module, wherein
the channel vector obtaining module is configured to obtain a channel vector of a compressed sensing-based near-field channel on which estimation is to be performed; and
the estimate calculation module is configured to input the channel vector into a channel estimation model constructed by a deep neural network, whereby the channel estimation model converts the channel vector into a polar-domain channel vector by a built-in sparse transformation matrix; compress the polar-domain channel vector into a signal vector by a built-in sensing matrix; add noise to the signal vector, and obtain a received signal vector; input the received signal vector into a built-in LAMP algorithm layer, whereby the LAMP algorithm layer performs an iterative calculation on the received signal vector by a built-in soft-thresholding function, and obtain an estimated polar-domain channel vector corresponding to the polar-domain channel vector, wherein the soft-thresholding function is calculated based on a built-in linear transformation parameter, nonlinear transformation parameter, and linear transformation matrix; and convert, by the built-in sparse transformation matrix, the estimated polar-domain channel vector into an estimate of the compressed sensing-based near-field channel on which estimation is to be performed.

9. A terminal device, comprising: a processor, a memory, and a computer program stored in the memory and configured to be executed by the processor, wherein the processor executes the computer program to implement the compressed sensing-based near-field channel estimation method for XL-MIMO according to claim 1.

10. A non-transitory storage medium, wherein the non-transitory storage medium comprises a stored computer program, and the computer program is run to control a device on which the non-transitory storage medium is located to perform the compressed sensing-based near-field channel estimation method for XL-MIMO according to claim 1.
